(19) United States
(12) Patent Application Publication
(10) Pub. No.: US 2013/0290033 A1
(43) Pub. Date: Oct. 31, 2013

(54) SYSTEMS AND METHODS FOR ELECTRONIC RECEIPT BASED CONTENTS INVENTORY AND CASUALTY CLAIM PROCESSING

(71) Applicants: Andrew G. Reeser, Heyworth, IL (US); Stacy L. Kennedy, Bloomington, IL (US); Shawn M. Call, Bloomington, IL (US)

(72) Inventors: Andrew G. Reeser, Heyworth, IL (US); Stacy L. Kennedy, Bloomington, IL (US); Shawn M. Call, Bloomington, IL (US)

(73) Assignee: State Farm Mutual Automobile Insurance Company, Bloomington, IL (US)

(21) Appl. No.: 13/455,677

(22) Filed: Apr. 25, 2012

(51) Int. Cl. G06Q 40/08

(52) U.S. Cl. 705/4

(57) ABSTRACT

A method for investigating a casualty claim using a programmed computer system may include receiving a prompt to create a contents inventory, the prompt including an identification of one or more email accounts associated with an insured, analyzing the one or more email accounts for information related to the acquisition of personal property, and using the information related to the acquisition of personal property to generate a contents inventory for investigation of the casualty claim.

### TECHNICAL FIELD

The present disclosure relates generally to systems and methods for producing a contents inventory and processing casualty claims. These systems and methods may include computer, internet and/or cloud computing, hardware, software, and data stores to gather and process data for electronic receipt based contents inventories to be used in casualty claim processing.

### BACKGROUND

Homeowner's insurance, which may also be referred to as home insurance, a dwelling policy, and/or hazard insurance (HOI), may include multiple insurance policies and/or products intended to cover a variety of losses related to real property. For example, homeowner's insurance may provide coverage for losses or damage to the structure and/or fixtures of a home, compensation for loss of use of the home, losses or damage of the contents of the home, and/or liability coverage for accidents that occur on the insured premises. Various additional types of insurance may also cover losses to the personal property and contents (e.g., automobile policies and/or renter's insurance).

If a policy-holder suffers a loss and believes that loss may be covered by one or more insurance policies, that policy-holder may initiate a claim process. Claims may be filed directly by an insured (e.g., through a phone call to the insurance company and/or submitting a claim form on-line or by mail). In some cases, claims may be initiated by an insurance agent or broker acting on behalf of an insured. The insured may be an individual, a family, and/or a business entity.

In many claim handling processes, an insurer may appoint a claim processor (also known as a claim handler or claim adjuster) to investigate the claim. The investigation may include exploring and/or determining whether the policy covers the loss asserted. The investigation may also include determining the monetary value of any losses incurred and/or making the payments due under the policy. In practice, a claim processor may be forced to balance the risk of overpayment (also referred to as overpayment leakage) with the costs of investigation and customer satisfaction.

In order to assess the replacement and/or market value for any lost items, a claims processor often requests a description of the claimed items, including purchase price, date of purchase, and/or proof-of-purchase or receipts. Claims involving inventory and/or personal property can often be simplified if the insured has a detailed inventory of the goods present before the loss. Some insurance companies provide a sample “home inventory checklist” to their insured customers to assist with the creation of an inventory.

Although most insurance companies encourage their insured customers to generate a contents inventory prior to their loss, most customers do not do so until after they have suffered a loss. Once personal property is lost and/or damaged, it is difficult to accurately identify the number, type, model number, and/or other details of the personal property. In addition, it is difficult to offer documentation related to the personal property, as receipts may have been damaged or lost at the same time.

In other cases, homeowners may keep grossly inadequate records of the contents in their homes. An inventory of dwelling contents is particularly difficult and time consuming to keep up to date. People who have lived in the same dwelling for a number of years may have no documentation of what they own. Further, even if a homeowner keeps an inventory, the inventory records may be destroyed in the same catastrophic event that destroys the contents themselves.

When the insured is responsible for creating a contents inventory after a loss, the lack of documentation raises the risk of insurance fraud. That risk potentially raises the tensions between a claims processor, the insurance company, and the insured. Alternatively, policy holders may have no evidence to corroborate their truthful recollections of the contents they possessed prior to a loss.

In some cases, it may be particularly difficult to create a contents inventory after a total loss. Catastrophic disasters such as hurricanes, tornadoes, earthquakes, fire, etc., may completely destroy a dwelling and all of its contents. If not completely destroyed, the contents may become so damaged as to be unrecognizable by the policy holder. Further, if the policy holder is deceased or incapacitated, there may not be anyone available who can recollect what contents were in the dwelling prior to the catastrophic event. In geographic areas where catastrophic events are more likely, there is greater need to have up-to-date inventories what is owned. Complete content inventories facilitate full, fair, and accurate insurance claim processing.

### SUMMARY

In accordance with the teachings of the present disclosure, disadvantages and problems associated with existing casualty claims processing have been reduced.

The present disclosure includes methods and systems related to generating a contents inventory using electronic receipts and email. The practices of the present disclosure may be used before a loss to generate a contents inventory and/or to supplement the generation of a contents inventory. A contents inventory may be used to assess the proper level and/or amount of coverage for casualty insurance. In addition, the practices of the present disclosure may provide improved accuracy and documentation for the generation of a contents inventory after a loss has occurred. The practices of the present disclosure may provide identification of goods (e.g., model number and/or serial number), the source of goods, the date of purchase and/or delivery, and/or the purchase price.

According to one aspect of the invention, a method for investigating a casualty claim using a programmed computer system may include receiving a prompt to create a contents inventory, the prompt including an identification of one or more email accounts associated with an insured, analyzing the one or more email accounts for information related to the acquisition of personal property, and using the information related to the acquisition of personal property to generate an contents inventory for investigation of the casualty claim.

According to another aspect of the invention, a method for compiling a contents inventory using a programmed computer system may include receiving a prompt to generate a contents inventory including an identification of an insured and permission to access to one or more email associated with the insured, analyzing the one or more email accounts for information related to the acquisition of personal property, and using the information related to the acquisition of personal property to generate a contents inventory.

According to another aspect of the invention, a computer system for investigating a casualty claim may include a processor, a memory, and a set of computer readable instructions stored in the memory. When the set of computer readable instructions is executed by the processor the computer system may receive a prompt to create a contents inventory, analyze the one or more email accounts for information related to the acquisition of personal property, and use the information related to the acquisition of personal property to generate a contents inventory for investigation of the casualty claim. The prompt may include an identification of one or more email accounts associated with an insured.

According to another aspect of the invention, a computer system for facilitating casualty claim investigation may include a processor, a memory, an input for receiving a prompt to create a contents inventory. The prompt may include an identification of one or more email accounts associated with an insured. The processor may be configured to analyze the one or more email accounts for information related to the acquisition of personal property. The processor may be configured to use the information related to the acquisition of personal property to generate a contents inventory for investigation of the casualty claim.

According to another aspect of the invention, a computer readable medium may contain a set of computer readable instructions that, when loaded into a computer, configure that computer to receive a prompt to create a contents inventory, the prompt including an identification of one or more email accounts associated with an insured, to analyze the one or more email accounts for information related to the acquisition of personal property, and to use the information related to the acquisition of personal property to generate a contents inventory for investigation of the casualty claim.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a computing and information handling system, according to certain embodiments of the present disclosure.

FIGS. 2A-2B illustrate a method 200 for generating a contents inventory using a programmed computer system.

FIG. 3 illustrates a contents inventory, according to certain embodiments of the present disclosure.

FIG. 4 illustrates a process for creating an electronic receipts based contents inventory, according to certain embodiments of the present disclosure.

FIGS. 5A-5K show various screen shots from a contents inventory application incorporating certain aspects of the present disclosure.

FIGS. 6A-6D show various screen shots from a contents inventory application incorporating certain aspects of the present disclosure.

### DETAILED DESCRIPTION

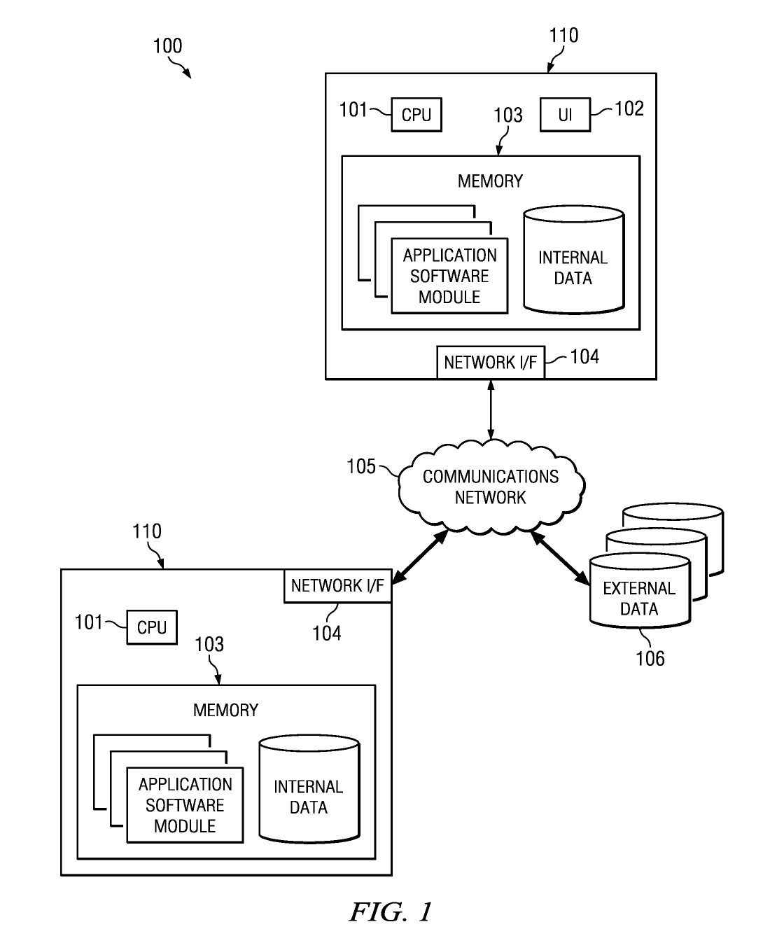

Preferred embodiments and their advantages over the prior art are best understood by reference to FIGS. 1-6 herein. The present disclosure, however, may be more easily understood in the context of a high level description of certain embodiments.

FIG. 1 illustrates a computing and information handling system according to one embodiment of the present disclosure. System 100 comprises one or more computers 110. Each computer 110 may include a central processing unit (CPU) 101, a user interface 102, a memory 103, and a network interface 104. The memory 103 comprises one or more application software modules and one or more internal data stores. System 100 may include a communication network 105 and external data stores 106.

Computer 110 may include any type of general purpose or specialized computer system. In some embodiments, computer 110 may include a personal computer (e.g., an x86-based computer) running an operating system such as UNIX™, OSX™, or WINDOWS™. In some embodiments, computer 110 may include a server or workgroup class system such as those offered by IBM™, HP™, COMPAQ™, or ORACLE™. In other embodiments, computer 110 may be a mainframe system such as an IBM ZSERIES™ mainframe. In some embodiments, computer 110 may include a mobile device such as a laptop, tablet, or smart phone.

CPU 101 may include any general purpose processor (e.g., ARM™, X86, RISC, and Z10™). Memory 103 may include any form or combination of volatile and/or non-volatile tangible computer readable medium including semiconductor memory (e.g., RAM, ROM, flash, EEPROM, and MRAM), magnetic memory (e.g., magnetic hard drives, floppy disks, and removable drive cartridges), optical memory (e.g., CD-ROM, DVD-ROM, BLURAY™ ROM, and/or holographic storage). Memory 103 may provide transient and/or persistent storage of application software modules and/or internal data. Memory 103 may provide storage for operating system software (e.g., device drivers and/or system configurations). Network interface 104 may provide data interconnection—via communications network 105—between computer 110 and external data 106.

Internal data may include data stored as bitmaps, vectors, objects, tables, and/or files. Internal data may be associated with various aspects of software and/or hardware associated with computer system 100. For example, internal data may include email folders, archives, and/or other data related to electronic correspondence and/or email.

Application software modules may include software and/or firmware instructions and configuration information that provide instructions to CPU 101 to perform various steps of the methods, procedures, and functions disclosed herein. Application software may be implemented in a compiled and/or interpreted environment. In some embodiments, application software modules may be implemented in a high-level programming language (e.g., COBOL, FORTRAN, C, C++, SmallTalk, JAVA™, C$, assembly language, JAVA™ server pages (JSP), application server pages (ASP), or VISUAL BASIC™).

External data 106 may include any form of data source. In some embodiments, external data 106 may be received on an optical disk and imported into an internal data store for further processing. In some embodiments, external data 106 may include an external data store hosted on a computer accessible using communications network 105. External data 105 may be available for on-demand retrieval or may be pushed by a data provider. External data 106 may be transferred to computer 110 in whole or in part. This transfer may be periodic, on demand, or as changes occur. In some embodiments, external data 106 may include email data stored on servers maintained by third party providers (e.g., HOTMAIL™, GMAIL™, YAHOO™, etc.). In some embodiments, external data may include email data stored by a user on a proprietary system using email software (e.g., EUDORA™, OUTLOOK™, etc.).

Communications network 105 may include a heterogeneous or homogeneous set of physical media (e.g., optical fiber, radio links, and/or copper wires) and protocol stacks (e.g., ETHERNET™, FDDI, GSM, WIMAX™, LTE, USB™, BLUETOOTH™, FIOS™, 802.11, and/or TCP/IP).

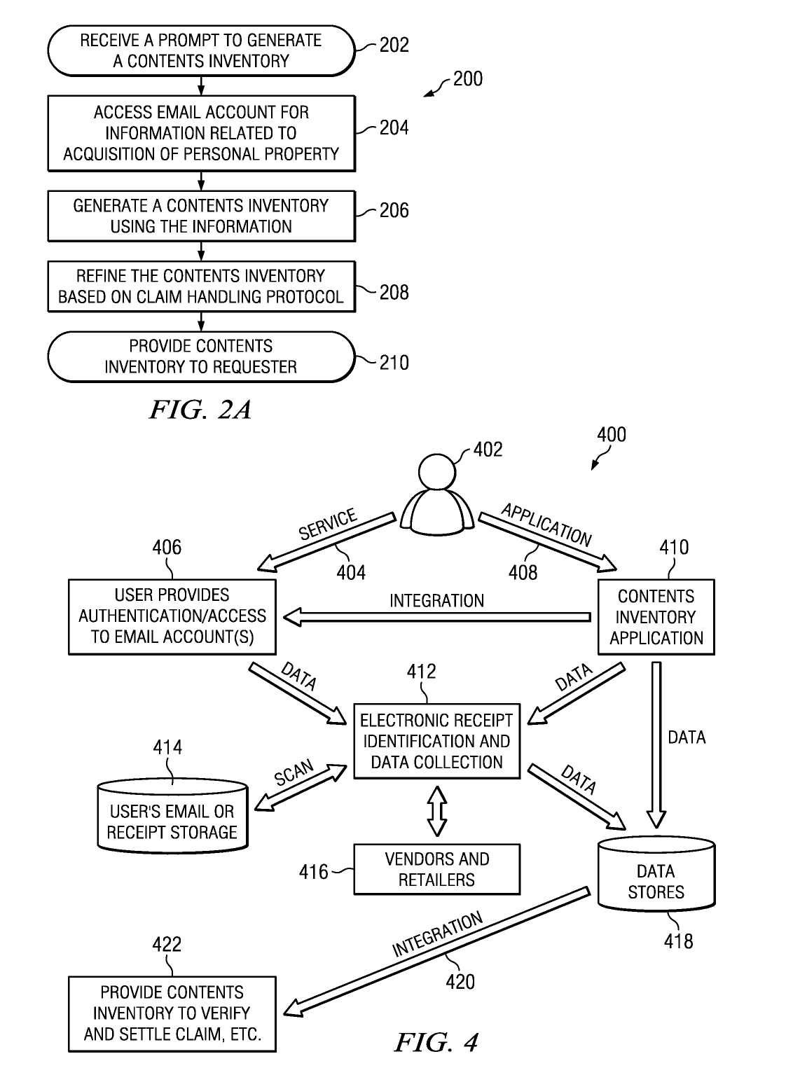

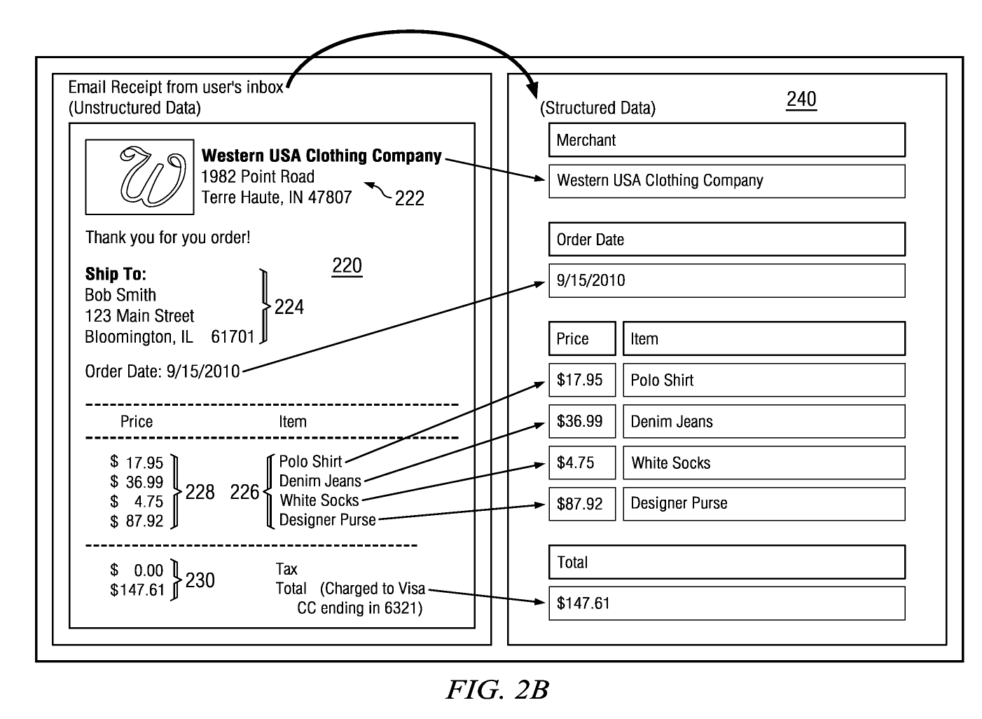

FIGS. 2A-2B illustrate a method 200 for generating a contents inventory using a programmed computer system. FIG. 2A provides a flow chart, illustrating method 200. In some embodiments, method 200 may be performed by an insurance company, a claims adjuster, and/or other parties. In some embodiments, practices of the present disclosure may include only some of the steps of method 200 and/or may include the identified steps in some other order.

Step 202 may include receiving a prompt to create a contents inventory. The prompt may include an identification of one or more email accounts associated with an insured. The prompt may be initiated by the insured directly. In some embodiments, the prompt may be initiated on behalf of the insured, including by a claims adjuster, an insurance agent, or an attorney working on behalf of the insured. The prompt may be submitted by email, through the internet, by phone, by mail, by text message, and/or by any other appropriate means of communication.

Step 204 may include accessing the one or more email accounts for information related to the acquisition of personal property. As the popularity of electronic communication has grown, an increasing number of purchases may be documented electronically. For example, purchases through web-based vendors (e.g., EBAY™, AMAZON.COM™ and BESTBUY.COM™) may include electronic purchase orders, confirmations, delivery notices, and/or receipts. Any of these electronic documents may be delivered by email and/or stored in a customer's email account.

Step 204 may include using any electronic documents present to gather data related to the requested contents inventory. For example, an electronic purchase order may include a model number, a purchase price, and/or the name of the vendor. As another example, an electronic receipt may include a model number, a purchase price, the date of purchase, and/or the name of the vendor.

FIG. 2B shows how the data in a receipt 220 may be transformed into a database entry 240 useful for the performance of method 200. For example, receipt 220 may include information in text format like a printed receipt. The text may include the name of the vendor or merchant 222, shipping and/or delivery information 224, a description of the items purchased 226, a purchase price 228, and/or a total 230. Step 204 may include transferring the unorganized data from receipt 220 into a format more useful for analysis as shown in a database entry 240.

Step 204 may include additional data gathering from the one or more email accounts and/or additional data files. For example, in some embodiments, an insured customer may use an application with his or her scanner to read paper receipts and/or other purchase documentation into electronic files. In some embodiments, an insured customer may use a smart phone equipped with OCR capabilities to capture printed documents and store purchase data in an email account and/or some other data files. As another example, step 204 may include accessing a third-party aggregator's external data files in order to identify additional purchase data related to the insured customer. As another example, step 204 may include accessing expense reports generated by one or more employees of an insured company.

Step 206 may include generating a contents inventory using the information and/or data gathered in step 204. For example, step 206 may include aggregating any purchase data available through the one or more email accounts and compiling a list of all purchases.

Step 208 may include refining the contents inventory based on claims handling protocol. For example, step 208 may include removing duplicate entries. As another example, step 208 may include analyzing the goods and identifying consumable goods (e.g., food, diapers, and/or beverages) which may have been consumed prior to loss. As another example, step 208 may include identifying particular goods which are not eligible for coverage, including goods subject to specific disclaimers and/or exemptions.

Step 210 may include providing the contents inventory to the requester. For example, the contents inventory may be delivered to the insured customer and/or the claims adjuster. In some embodiments, the contents inventory may be provided in order to assess the proper amount of coverage for the insured. In other embodiments, the contents inventory may be provided for use in the investigation of a claim. For example, the contents inventory may identify goods that the customer had forgotten and/or was unable to document for lack of receipts and/or other evidence of purchase. As another example, the contents inventory may show that a customer had disposed of goods and/or property prior to the loss. As another example, the contents inventory may show that the age of a particular item depreciated its value prior to loss. In some embodiments of the present disclosure, an insured customer may verify the contents inventory before it is used for any other purpose.

In some embodiments, method 200 may be employed as part of a larger claims handling process. A claim handling process may begin with a notification of loss from the insured and/or a representative of the insured. The notification may include an estimate of the total value of items lost, damage to a dwelling, and/or additional information related to the loss (e.g., a description of the loss event, the date of the loss event, and/or any official documentation from a fire department, police department, etc.). In simple cases, a claim processor may be authorized to settle a claim based solely on a statement by the insured.

In more complicated cases, the claim processor may require documentation based on the character and/or amount of the claim. In some cases, a claim processor may direct a claimant to list their own inventory and/or provide documentation to support the claimed items. In those cases, method 200 may provide useful documentation through electronic receipts that simplify the claim process for the insured and/or the claim processor. Customers and/or claim processors using method 200 may reduce the investment of time and effort required to fully populate, document, and/or verify their contents inventory.

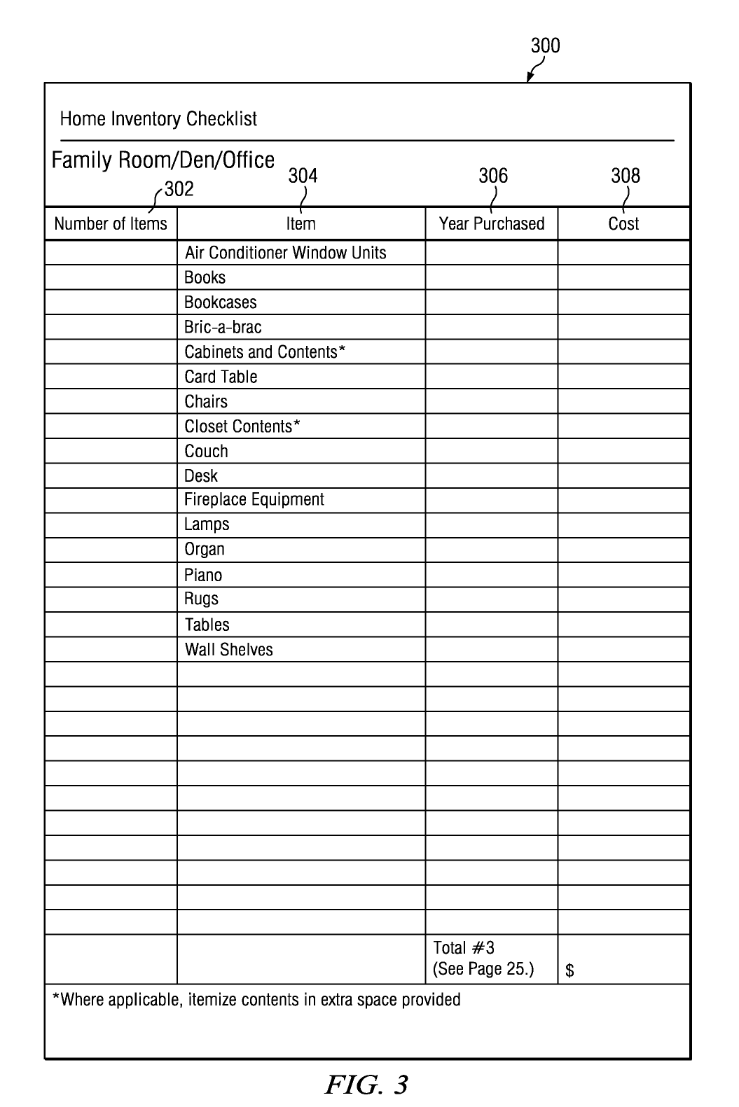

FIG. 3 illustrates a form 300 for a contents inventory, according to certain embodiments of the present disclosure. In the embodiment shown, form 300 includes fields for various information. For example, form 300 includes field 302 identifying the number of items, field 304 identifying the description of an item, field 306 identifying the purchase date, and field 308 identifying the purchase price. In other embodiments, form 300 may include additional fields. For example, form 300 may include vendor identification and/or current replacement value.

FIG. 4 illustrates a process 400 for creating an electronic receipts based contents inventory, according to certain embodiments of the present disclosure. Process 400 may be used to generate a contents inventory for use in claim adjustment, to price an insurance policy, and/or to inform an insured as to the total value of the contents of his or her dwelling.

Alternative embodiments of process 400 may include additional steps, may eliminate steps, or may perform the steps shown in an alternative order.

Initiator 402 may include any person or entity who initiates process 400. For example, initiator 402 may include an insured customer making a claim against his or her homeowner's policy. In another example, initiator 402 may include an insurance agent initiating a request for a contents inventory for use in pricing coverage for a potential customer. In another example, initiator 402 may include a claims adjuster requesting a contents inventory to assess the total value of a customer's loss.

Process 400 may include more than one access portals for initiator 402. For example, at step 404, initiator 402 may directly request an electronic receipt-based contents inventory through his or her insurer. At step 406, initiator 402 may be asked to provide email account access. Step 406 may include providing email account addresses, passwords, and/or alternative authorizations allowing a contents inventory application 410 to access data associated with the email account or accounts.

As another example, at step 408, initiator 402 may initiate a contents inventory application 410 to generate an electronic receipt-based contents inventory. For example, initiator 402 may purchase and/or download a contents inventory application 410 that resides on his or her computer system 110. As another example, initiator 402 may subscribe to and/or purchase a contents inventory application 410 residing on a vendor computer 110, a server system, and/or a web-based system.

Contents inventory application 410 may be any application software configured to generate electronic receipt-based contents inventories as described herein. Contents inventory application 410 may include software, hardware, and/or firmware provided by an insurance company and/or by a third-party processor. Contents inventory software 410 may reside on an insurance company computer 110 and/or server, on a third party computer 110 and/or server, and/or on a computer 110 owned by initiator 402 and/or an insured customer. In some embodiments, contents inventory application 410 may request and/or gather purchase data directly from initiator 402.

In some embodiments, contents inventory application 410 may include additional data gathering processes. For example, contents inventory application 410 may allow a user to upload photographs of goods and/or insured items to document their presence in the home. As another example, contents inventory application 410 may allow a user to manually enter data related to his or her contents inventory.

At step 412, contents inventory application 410 integrates with the email account access provided in step 406 to collect data from the designated email account(s). The user's email and/or receipt storage 414 may reside on the insured's computer 110, the initiator's 402 computer 110, a third-party email storage unit 106, and/or any other data storage and/or memory associated with the designated account(s). In step 412, process 400 may aggregate data collected from any location and/or source.

In some embodiments, step 412 may include accessing data from vendors and/or retailers to supplement and/or confirm data collected from the initiator 402. For example, step 412 may include accessing a user's account with a vendor (e.g., AMAZON.COM™ and/or EBAY.COM™) to gather data related to purchases (e.g., purchase date and/or price, etc.). As another example, step 412 may include gathering vendor data to assess replacement value and/or current market value.

Data gathered in various steps of process 400 may be stored in data stores 418. In some embodiments, data stores 418 may include resources associated with the insurer, the insured, the initiator, and/or third party providers.

At step 420, process 400 may use any of the data compiled in data stores 418 to create the contents inventory requested by the initiator 402. For example, step 420 may include eliminating duplicate entries, verifying replacement and/or market value, organizing the contents inventory by room, removing consumable goods (e.g., diapers and/or perishable food), and/or any other data processing and/or integration step useful to initiator 402 and/or the insurance company processes.

At step 422, process 400 may provide an electronic receipt-based contents inventory. As described more fully above, the electronic receipt-based contents inventory may be used in a variety of ways, including claims processing, policy limit evaluations, and/or fraud detection. The electronic receipt-based contents inventory may be provided to customers, insurance agents, claims adjusters, and/or any other appropriate party. In some embodiments, step 422 may include verification by the customer that the items listed were accurate, were present at the time of loss, and/or were not recovered or repairable.

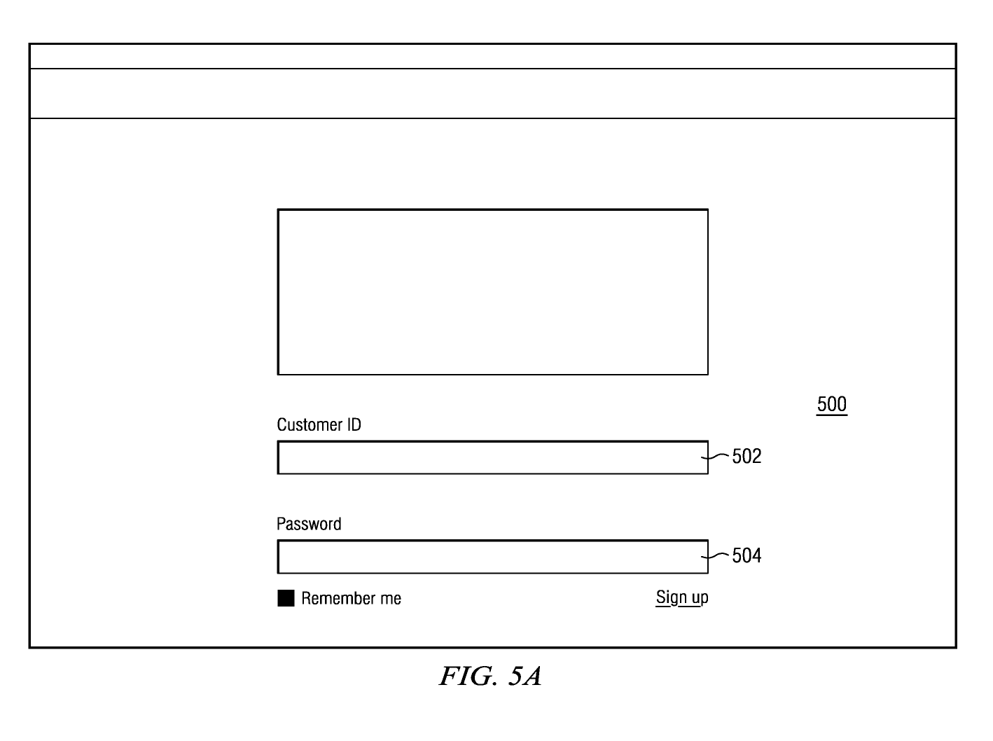

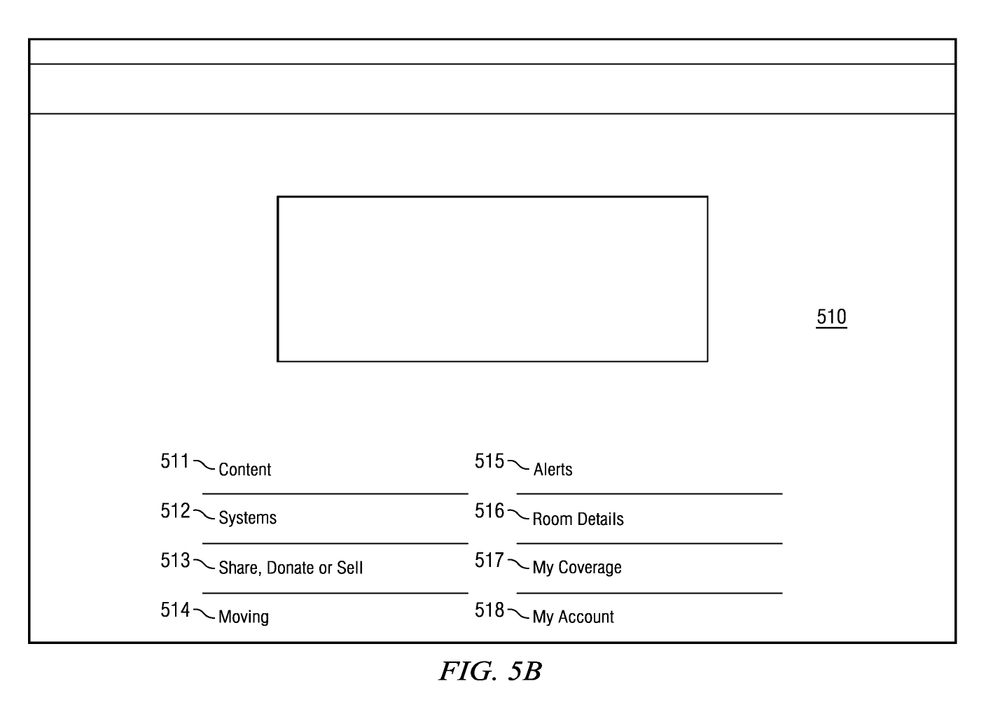

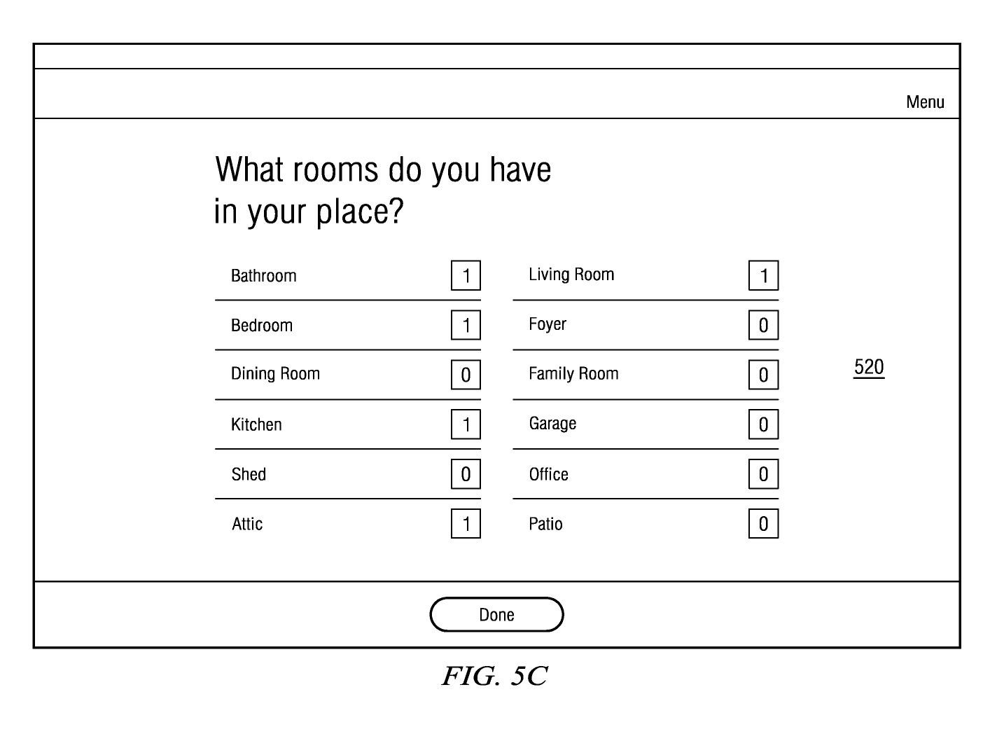

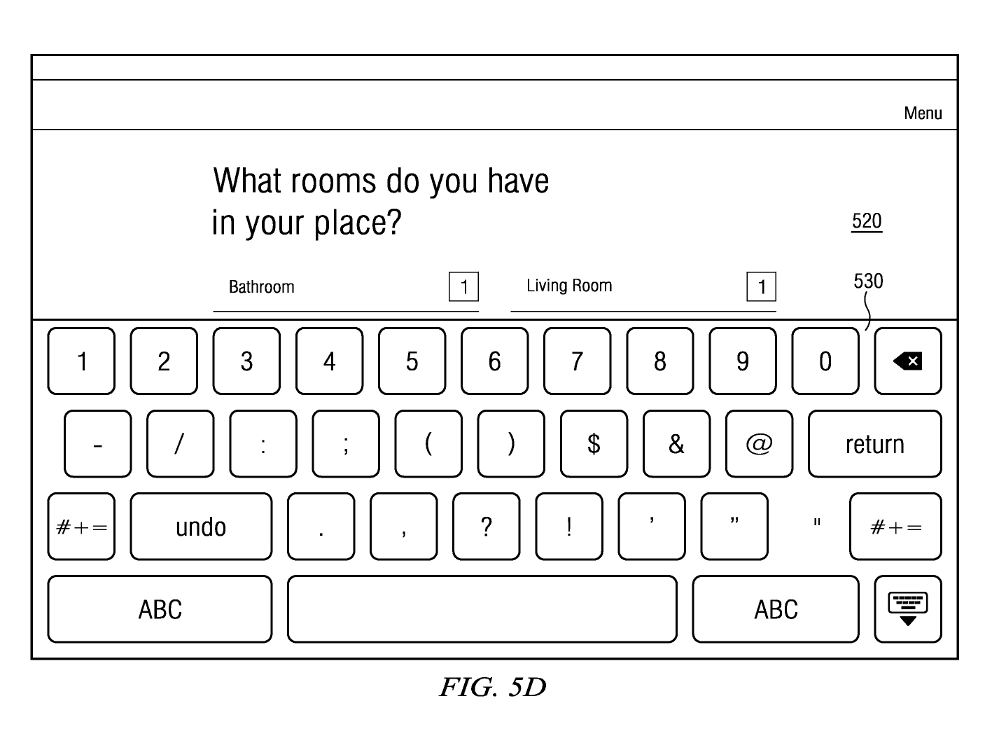

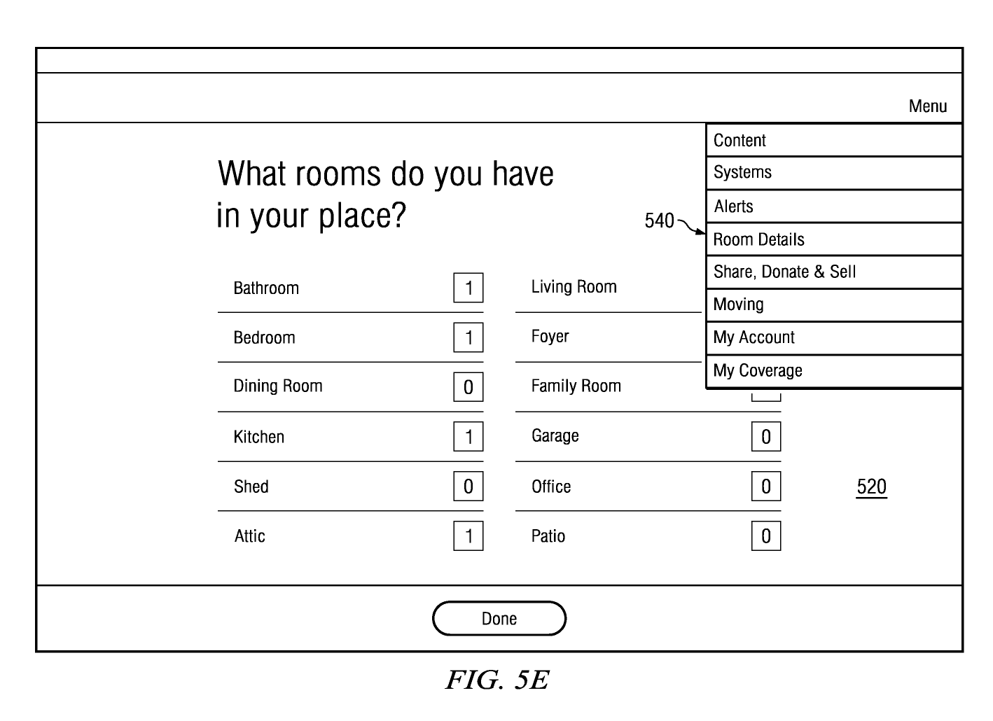

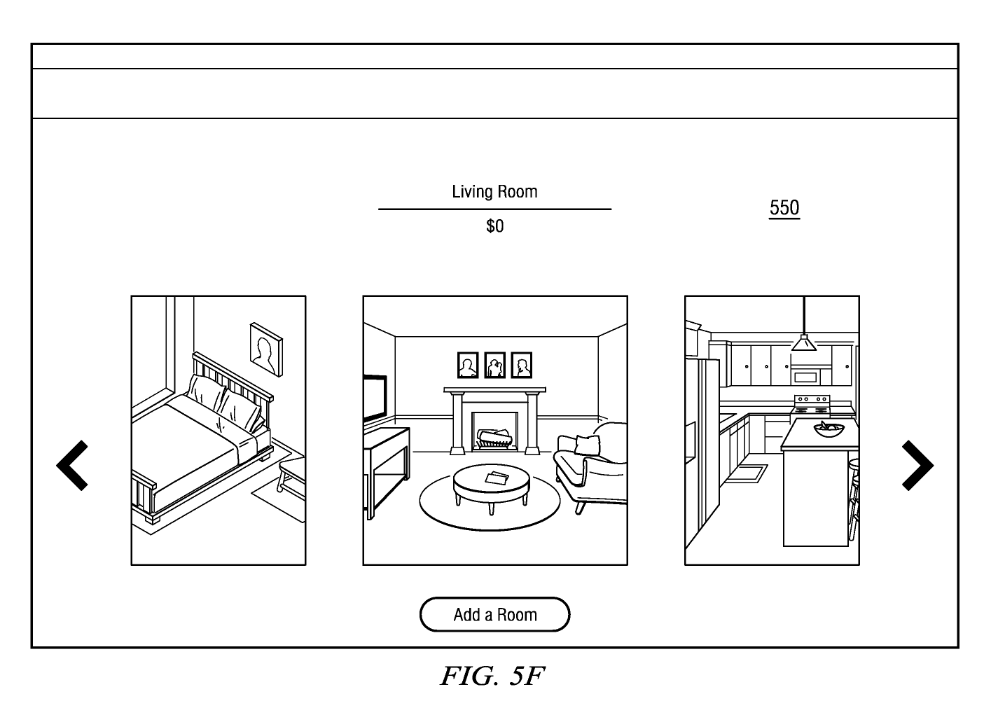

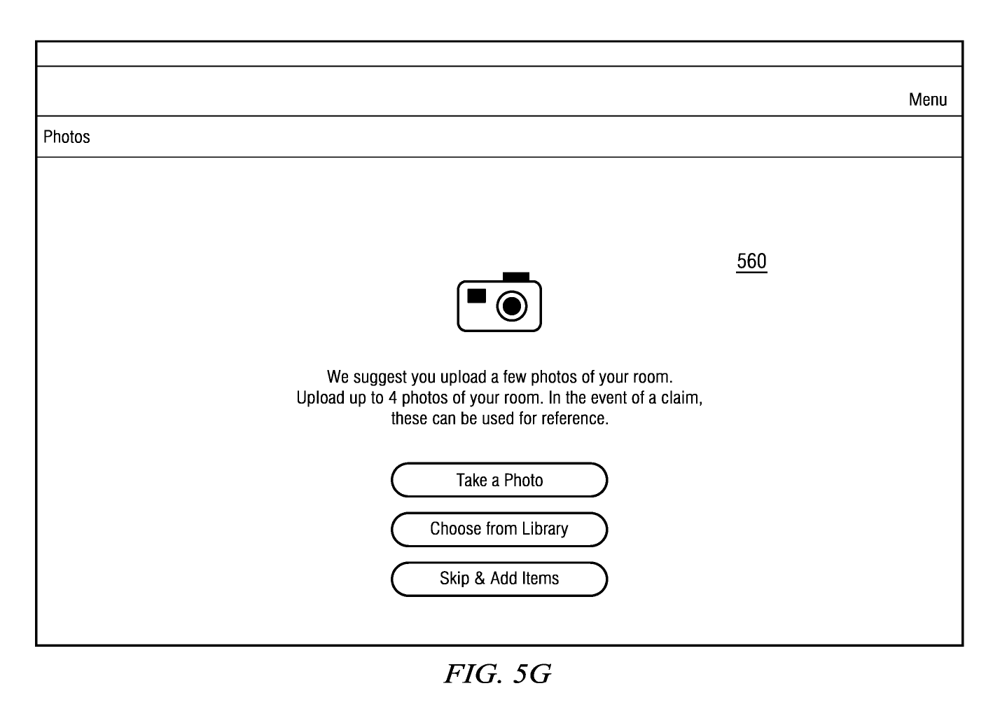

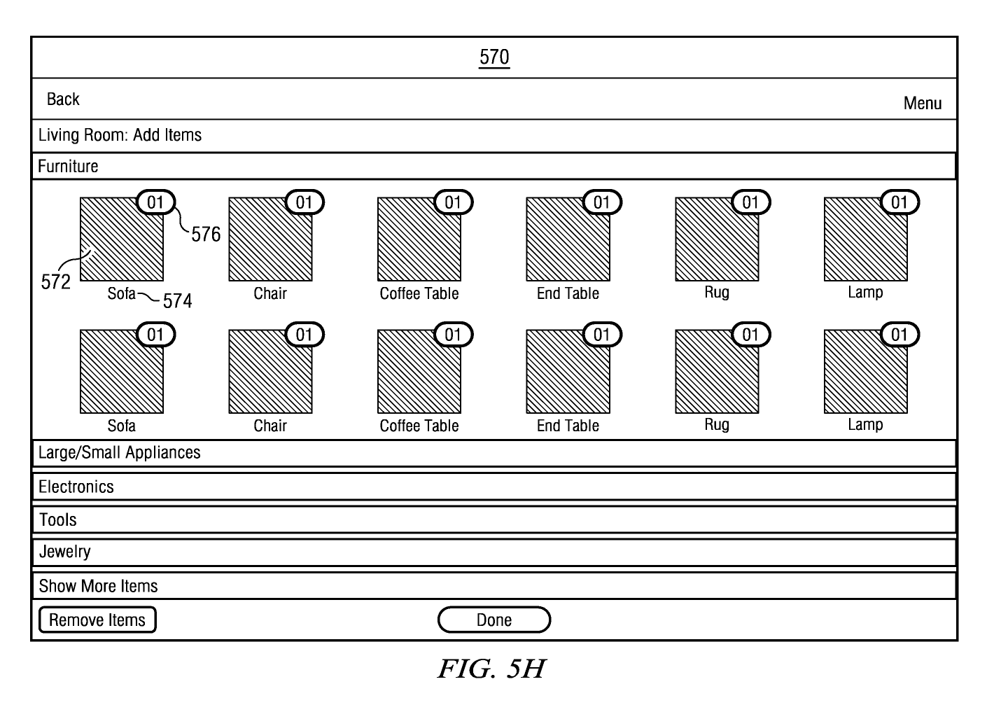

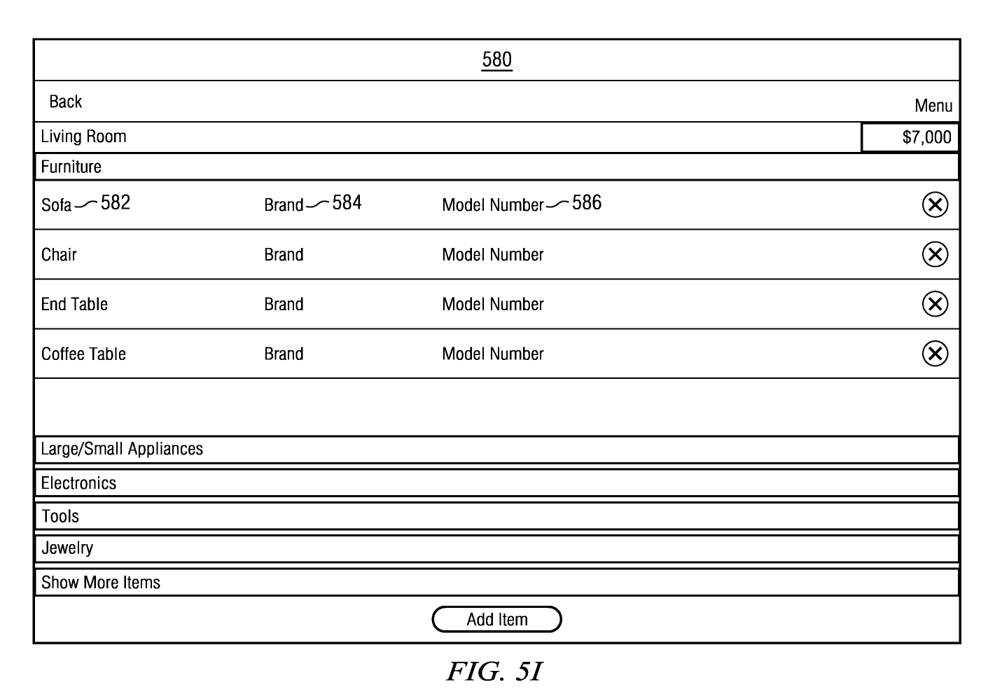

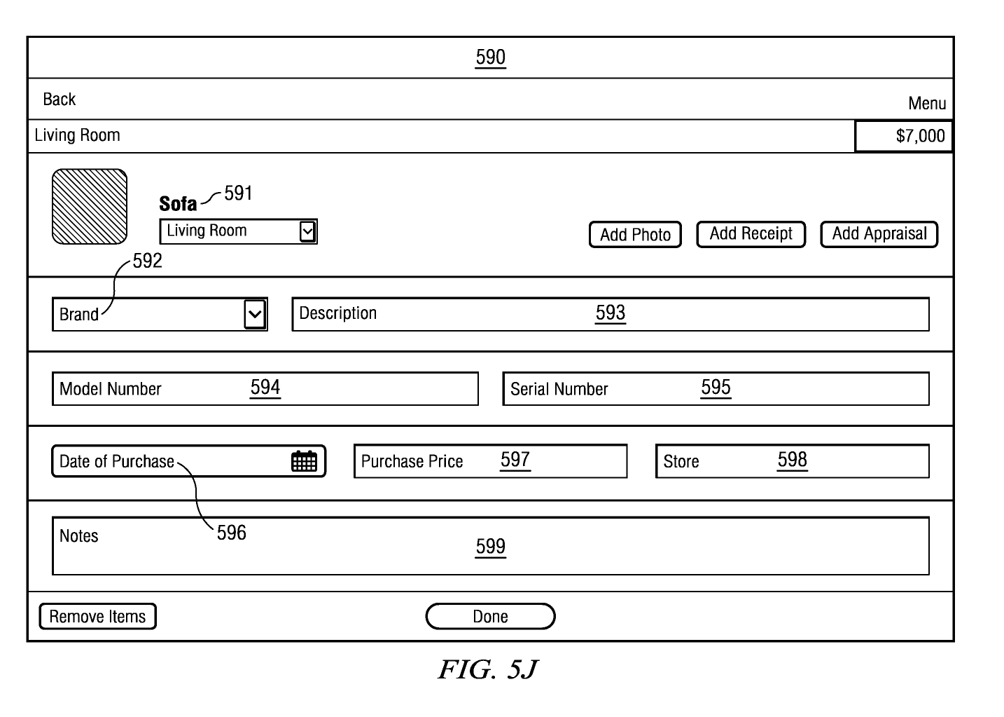

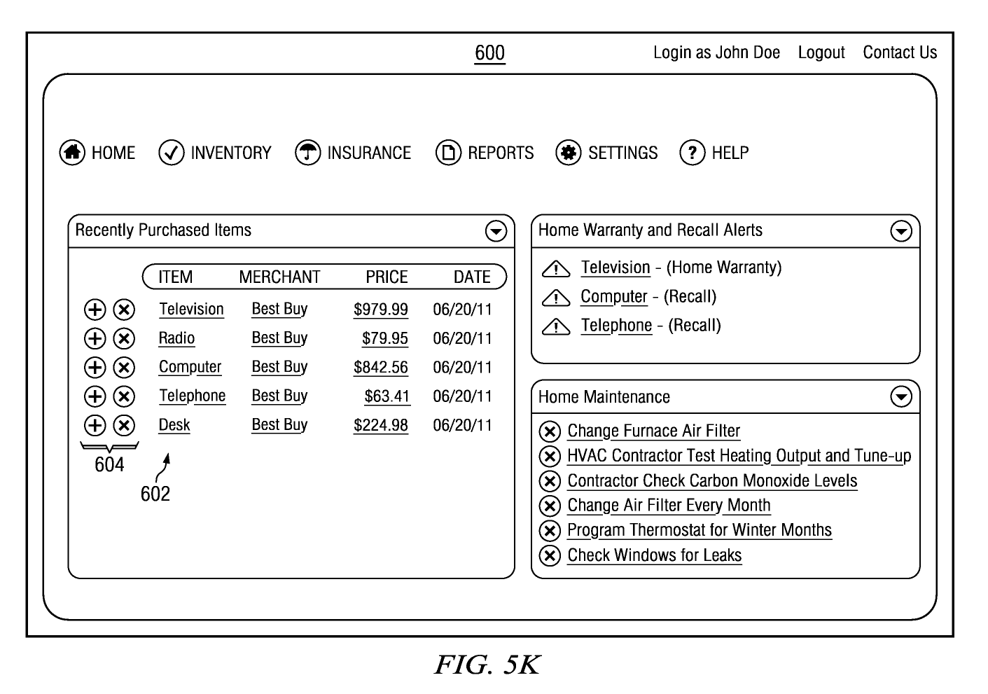

FIGS. 5A-5K show various screen shots from an example contents inventory application 410a incorporating certain aspects of the present disclosure. FIG. 5A shows a welcome screen 500 that may be used to enter contents inventory application 410a, including various data fields. For example, welcome screen 500 may request customer id 502 and/or password 504.

FIG. 5B shows a main menu screen 510 that may allow a user to navigate through various aspects of contents inventory application 410a. For example, the user may elect to complete contents inventory application 410a in multiple sessions. As another example, the user may return to contents inventory application 410a to update his or her contents inventory after a new purchase and/or after removing contents from the home. Menu screen 510 may include any navigation options useful for the user or a claim processor. For example, main menu screen 510 may provide options as shown in FIG. 5B, including options to jump to: contents 511, systems 512, share, donate, or sell 513, moving 514, alerts 515, and/or room details 516. Menu screen 510 may also include options related to the user's insurance policy (e.g., my coverage 517 and/or my account 518).

FIG. 5C shows a preliminary screen 520 that may allow a user to enter data describing the various rooms in his or her dwelling. As shown in FIG. 5C, contents inventory application 410a may prompt the user with a list of various rooms. The user may be able to enter numbers to populate the list, click links to select rooms, and/or any other appropriate interface provided by contents inventory application 410a. For example, FIG. 5D shows preliminary screen 520 with a keypad overlay 530 allowing the user to type data into the fields. Keypad overlay 530 may represent an interface useful with a Smartphone and/or a tablet computer.

FIG. 5E shows preliminary screen 520 with a drop-down navigation menu 540. Menu 540 may allow the user to jump to various portions of contents inventory application 410a. In some embodiments, menu 540 may appear when a user indicates he or she has completed the data entry in preliminary screen 520. In other embodiments, menu 540 may be available by clicking a link and/or a button 542.

FIG. 5F shows a room summary screen 550 that may be used to enter additional rooms, to provide a summary of the contents of a room, and/or to indicate the total dollar value of items entered for that room. Some embodiments of contents inventory application 410a may include room-by-room lists of goods while others may provide other categories (e.g., electronics, clothing, appliances, etc.).

FIG. 5G shows an example photograph entry screen 560. Photograph entry screen 560 as shown may offer options for the user to upload photographs of the room and/or specific inventory items. In some embodiments, photograph entry screen 560 may be specifically linked to a particular room in the house. In other embodiments, photograph entry screen 560 may be accessible from the main menu 510 and/or linked to specific items in the inventory.

FIG. 5H shows an example electronic inventory 570 for a specific room. In the embodiment shown in FIG. 5H, the electronic inventory 570 represents a living room. Electronic inventory 570 may include pictures of inventory items 572, text descriptions 574, and/or the number of items of each category 576. Electronic inventory 570 may include links to specific descriptions of each item, as shown in FIG. 5I.

FIG. 5I shows an example line item inventory 580. Line item inventory 580 may include data useful for claim processing, including name 582, brand 584, and model number 586. Line item inventory 580 may also include any other data discussed above, including purchase price, purchase date, delivery date, replacement price, etc.

FIG. 5J shows another example of an inventory screen 590, including individual screens for each inventory item. Inventory screen 590 may include various data fields, including name 591, brand 592, description 593, model number 594, serial number 595, date of purchase 596, purchase price 597, vendor 598, and notes 599. Inventory screen 590 may include additional fields (e.g., quantity, warranty status, recall notices, etc.).

FIG. 5K shows an example web-based interface 600 providing options for populating a user's inventory from electronic receipts and/or email accounts. As described in more detail related to FIG. 4, a user may provide access to one or more email accounts. Interface 600 may include a list 602 and verification buttons 604. List 602 may show all items identified by method 200 and/or process 400, as examples, that are not currently in a user's contents inventory. Verification buttons 604 may provide the user the option to add those items individually and/or as a group to his or her inventory. In some embodiments, interface 600 may provide additional functionality. For example, interface 600 may include an option and/or a link to home warranties and recall alerts. Interface 600 may be able to compare a user's contents inventory with various databases from vendors, manufacturers, and/or wholesalers and provide data alerts to the user when an item is subject to a recall and/or its warranty expires.

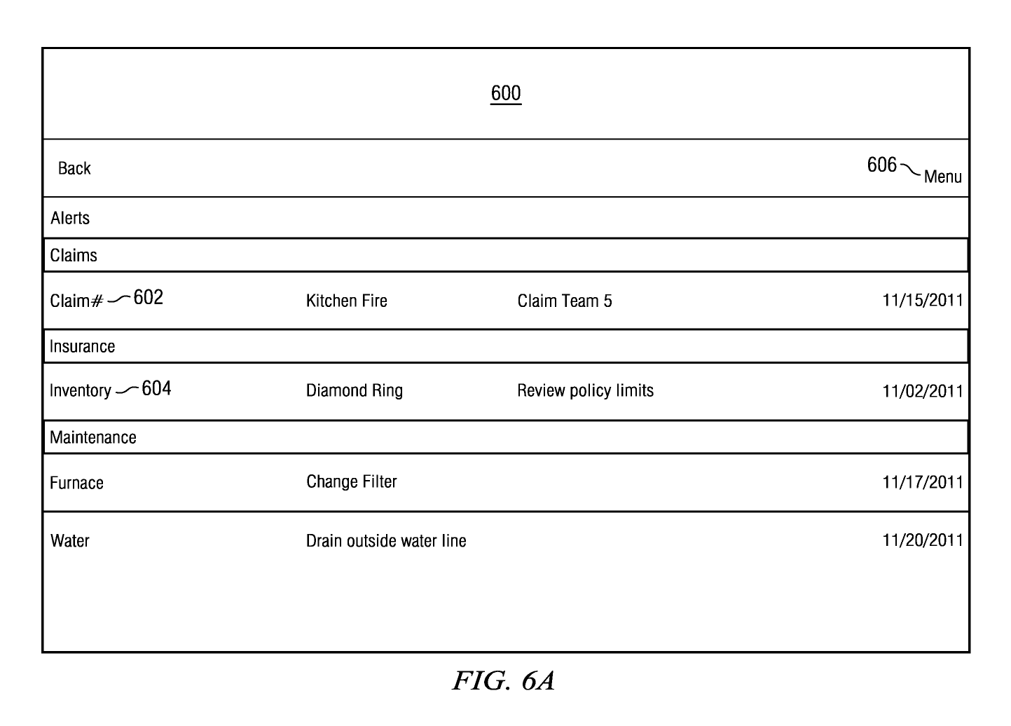

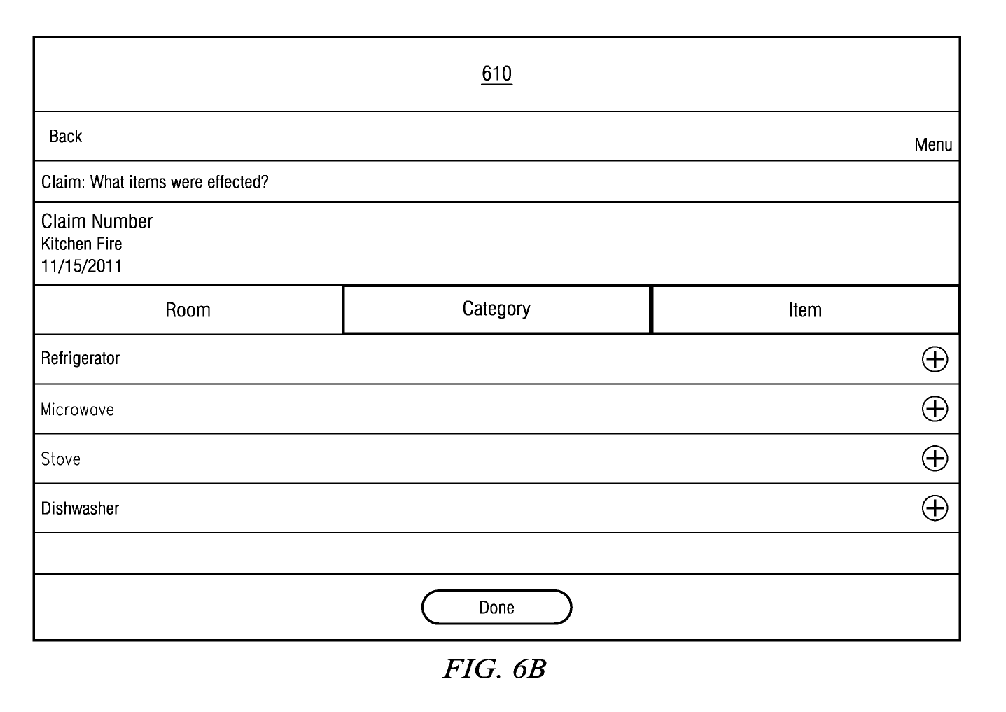

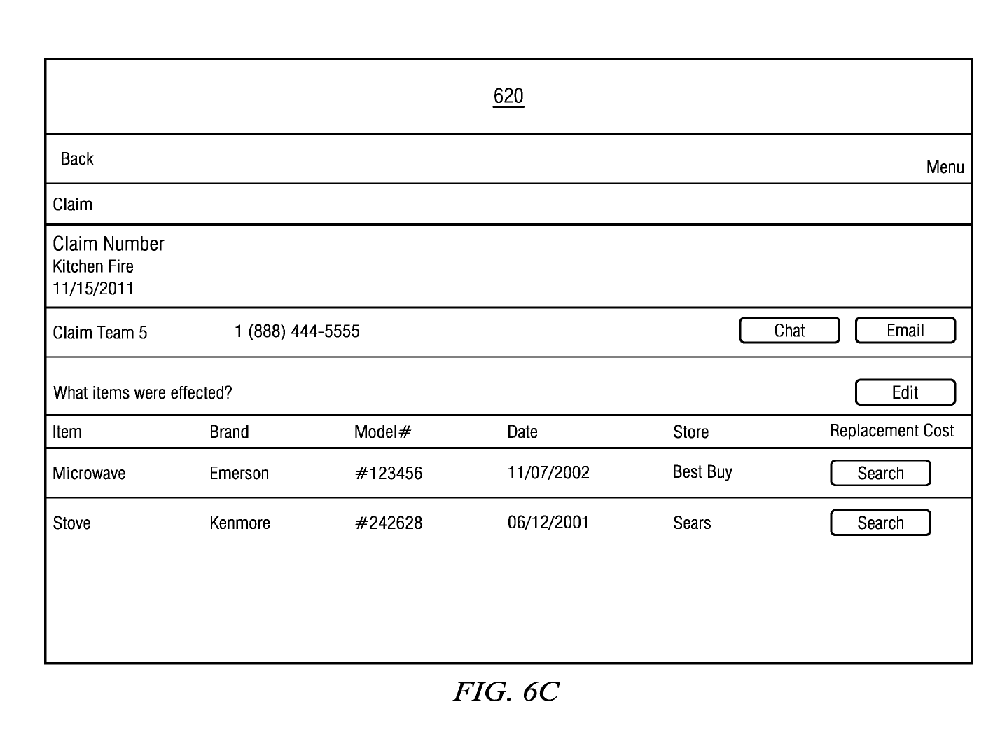

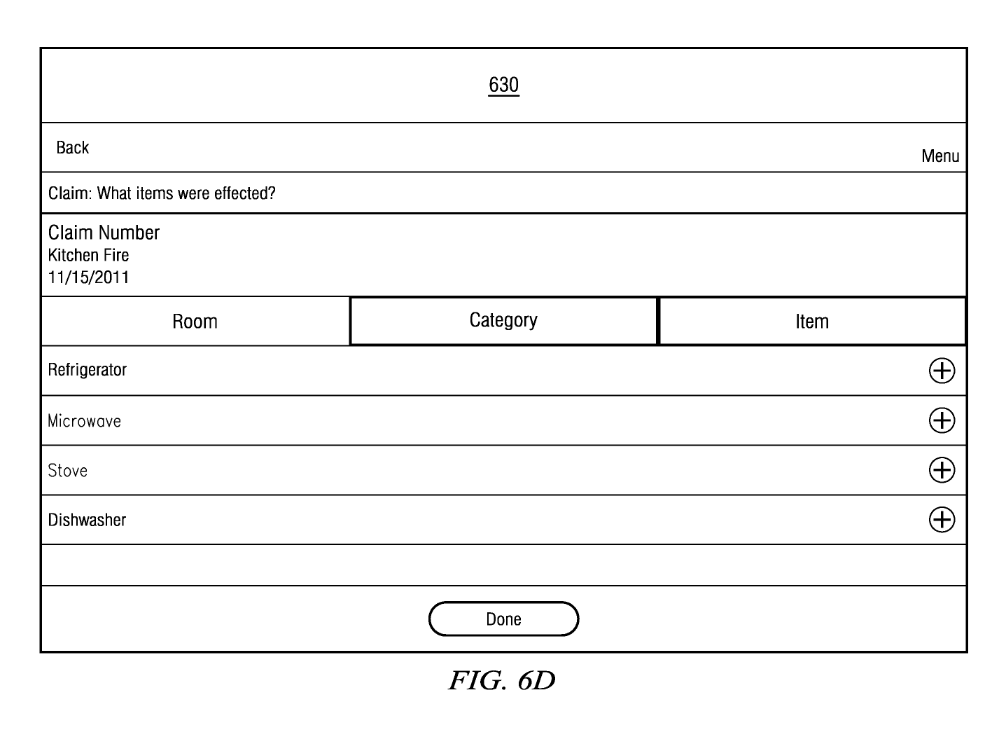

FIGS. 6A-6D show various screen shots from another example contents inventory application 410b incorporating certain aspects of the present disclosure. FIG. 6A shows a history screen 600. History screen 600 may include a listing of recent activity related to the user's account. For example, history screen 600 may display active claim 602, recent changes to inventory 604, and/or any other pertinent information. In addition, history screen 600 may include various menus and/or buttons 606 useful for navigating contents inventory application 410b.

FIG. 6B shows an example top level claim menu 610 which may allow a user to enter and/or select specific inventory items for inclusion in a pending claim. For example, claim menu 610 may link to a submenu 620, as shown in FIG. 6C, which lists various items and/or may provide buttons and/or menus to select the items. FIG. 6D shows an example evaluation menu 630 which may provide options for assessing replacement value for selected inventory items.

Contents inventory application 410b may be used to process insurance claims after a loss and/or to assess market value and coverage levels prior to a loss. In either case, the inventory items listed in submenu 620 may be added manually, by an electronic receipt-based inventory system, and/or any other appropriate means for generating a contents inventory.

For purposes of this disclosure, the embodiments described are exemplary—for example only. Although some of the embodiments are described in detail, persons having ordinary skill in the art will understand that various changes, substitutions, and alterations made to the example embodiments do not depart from their spirit and/or scope.

What is claimed is:

1. A method for investigating a casualty claim using a programmed computer system, the method comprising:
receiving a prompt to create a contents inventory, the prompt including an identification of one or more email accounts associated with an insured;
analyzing the one or more email accounts for information related to the acquisition of personal property; and
using the information related to the acquisition of personal property to generate a contents inventory for investigation of the casualty claim.

2. A method according to claim 1, further comprising initiating a casualty claim investigation.

3. A method according to claim 1, further comprising:
receiving a request to initiate a casualty claim investigation;
initiating the casualty claim investigation; and
generating the prompt to create a contents inventory.

4. A method according to claim 1, further comprising:
receiving a request to initiate a casualty claim investigation;
initiating the casualty claim investigation;
generating the prompt to create a contents inventory; and
using the contents inventory to assess the monetary value of the casualty claim.

5. A method according to claim 1, wherein the information related to the acquisition of personal property includes electronic receipts.

6. A method according to claim 1, wherein the information related to the acquisition of personal property includes electronic notification of delivery.

7. A method according to claim 1, wherein the information related to the acquisition of personal property includes messages confirming purchase.

8. A method according to claim 1, further comprising refining the contents inventory to select and remove items.

9. A method according to claim 1, further comprising receiving electronic copies of scanned receipts on behalf of the insured.

10. A method according to claim 1, further comprising receiving electronic copies of scanned receipts on behalf of the insured wherein the electronic copies of scanned receipts are generated by scanning the receipts with a Smartphone.

11. A method according to claim 1, further comprising submitting the contents inventory to the insured for confirmation.

12. A method according to claim 1, wherein the contents inventory includes the purchase date and purchase price of the personal property acquired.

13. A method for compiling a property inventory using a programmed computer system, the method comprising:
receiving a prompt to generate a property inventory including an identification of an insured and permission to access to one or more email associated with the insured;
analyzing the one or more email accounts for information related to the acquisition of personal property; and
using the information related to the acquisition of personal property to generate a contents inventory.

14. A method according to claim 13, further comprising receiving the prompt as part of the generation of a new casualty policy.

15. A method according to claim 13, wherein the information related to the acquisition of personal property includes electronic receipts.

16. A method according to claim 13, wherein the information related to the acquisition of personal property includes electronic notification of delivery.

17. A method according to claim 13, wherein the information related to the acquisition of personal property includes messages confirming purchase.

18. A method according to claim 13, further comprising refining the contents inventory to select and remove items.

19. A method according to claim 13, further comprising receiving electronic copies of scanned receipts on behalf of the insured.

20. A method according to claim 13, further comprising receiving electronic copies of scanned receipts on behalf of the insured wherein the electronic copies of scanned receipts are generated by scanning the receipts with a Smartphone.

21. A method according to claim 13, further comprising submitting the contents inventory to the insured for confirmation.

22. A method according to claim 13, wherein the contents inventory includes the purchase date and purchase price of the personal property acquired.

23. A computer system for investigating a casualty claim, the system comprising:
a processor;
a memory; and
a set of computer readable instructions stored in the memory and, when executed by the processor, configured to:
receive a prompt to create a contents inventory, the prompt including an identification of one or more email accounts associated with an insured;
analyze the one or more email accounts for information related to the acquisition of personal property; and
use the information related to the acquisition of personal property to generate a contents inventory for investigation of the casualty claim.

24. A computer system for facilitating casualty claim investigation, the computer system comprising:
a processor;
a memory;
an input for receiving a prompt to create a contents inventory, the prompt including an identification of one or more email accounts associated with an insured;
the processor configured to analyze the one or more email accounts for information related to the acquisition of personal property; and
the processor configured to use the information related to the acquisition of personal property to generate a contents inventory for investigation of the casualty claim.

25. A computer readable medium containing a set of computer readable instructions that, when loaded into a computer, configure that computer to:
receive a prompt to create a contents inventory, the prompt including an identification of one or more email accounts associated with an insured;
analyze the one or more email accounts for information related to the acquisition of personal property; and
use the information related to the acquisition of personal property to generate a contents inventory for investigation of the casualty claim.
